(19) United States
(12) Patent Application Publication
(10) Pub. No.: US 2025/0001675 A1
(43) Pub. Date: Jan. 2, 2025

(54) Stereolithography Apparatus for Improving Localized Planarity of a Transparent Sheet

(71) Applicant: 3D Systems, Inc., Rock Hill, SC (US)

(72) Inventors: Nickolas M. Clinton, Carlsbad, CA (US); David Sabo, San Diego, CA (US); Grant Draper, Escondido, CA (US); Samuel David Rohrbach, San Diego, CA (US); Charles W. Hull, San Diego, CA (US)

(21) Appl. No.: 18/753,010

(22) Filed: Jun. 25, 2024

Related U.S. Application Data
(60) Provisional application No. 63/510,957, filed on Jun. 29, 2023.

(51) Int. Cl. B29C 64/124; B29C 64/245; B29C 64/255; B29K 105/00; B33Y 10/00; B33Y 30/00; B33Y 80/00

(52) U.S. Cl. CPC B29C 64/124; B29C 64/245; B29C 64/255; B33Y 10/00; B33Y 30/00; B33Y 80/00; B29K 2105/256; B29K 2995/0026

(57) ABSTRACT

A 3D printing system includes a machine chassis, a vessel support, a gas pressure source, a build vessel, a light engine, and a lateral movement mechanism. The build vessel is supported by the vessel support and includes a transparent sheet. The vessel support includes a carriage having a top surface. The carriage is configured to be positioned along a lateral X-axis under the transparent sheet. The carriage defines an optical path and a fluid channel that at least partially surrounds the optical path. The gas pressure source is coupled to the fluid channel. Gas flowing from the gas pressure source and out of the fluid channel is configured to maintain a vertical spacing between the top surface of the carriage and the transparent sheet. The lateral movement mechanism translates and positions the carriage and light engine together along the lateral X-axis.

### CROSS-REFERENCE TO RELATED APPLICATIONS

This non-provisional patent application claims priority to U.S. Provisional Application Ser. No. 63/510,957, Entitled “Stereolithography Apparatus for Improving Planarity of a Transparent Sheet” by Nickolas M. Clinton et al., filed on Jun. 29, 2023, incorporated herein by reference under the benefit of U.S.C. 119(e).

### FIELD OF THE INVENTION

The present disclosure concerns an apparatus and method for manufacture of solid three dimensional (3D) articles from radiation curable materials in a layer-by-layer manner. More particularly, the present disclosure concerns an improved mechanism for obtaining high resolution 3D articles by a local control of flatness of a transparent sheet which forms part of an optical path.

### BACKGROUND

Three dimensional (3D) printers are in rapidly increasing use for manufacturing customized 3D articles. One class of 3D printers includes stereolithography printers having a general principle of operation including the selective curing and hardening of radiation curable (i.e., photocurable) liquids. One type of stereolithography system includes a containment vessel holding the photocurable liquid, a movement mechanism coupled to a support tray, and a light engine. The stereolithography system manufactures or fabricates a 3D article by selectively curing layers of the photocurable liquid along a build plane above a transparent sheet. There is a desire to produce articles having features sizes that are 10 microns or smaller in size. One challenge is the weight of a column of photocurable liquid distorting the transparent sheet which in turn impacts dimensional accuracy of a 3D article due to resultant variations in the optical path from light engine to build plane.

### SUMMARY

In a first aspect of the disclosure, a three-dimensional (3D) printing system is configured to manufacture a 3D article. The 3D printing system includes a machine chassis, a build vessel, a light engine, and a lateral movement mechanism. The machine chassis includes a vessel support and a gas pressure source. The build vessel is supported by the vessel support and includes a vessel base, a vessel wall, and a transparent sheet. The vessel base has a central opening. The vessel wall extends upward from the vessel base. The transparent sheet closes the central opening of the vessel base. The vessel wall and the transparent sheet cooperate to define a fluid reservoir for containing a photocurable fluid. The vessel support includes a carriage having a top surface. The carriage is configured to be positioned along a lateral X-axis under the transparent sheet. The carriage defines an optical path and a fluid channel that at least partially surrounds the optical path. The gas pressure source is coupled to the fluid channel. Gas flowing from the gas pressure source and out of the fluid channel is configured to maintain a vertical spacing between the top surface of the carriage and the transparent sheet. Without the gas flow, the transparent sheet would slide against the top surface of the carriage and potentially scratch or wear a lower surface of the transparent sheet. The light engine is configured to selectively transmit radiation through the optical path and to a build plane that is above the transparent sheet. The lateral movement mechanism translates and positions the carriage and light engine together along the lateral X-axis.

In one implementation the vessel base includes a recess that extends around the tension ring. A support frame clamps a peripheral edge of the transparent sheet. The support frame is mounted within the recess. The transparent sheet extends downward from the support frame, over a lower edge of the tension ring, and laterally between opposing sides of the tension ring. The transparent sheet provides a lower bound for photocurable liquid that is disposed within the build vessel.

In another implementation the lateral movement mechanism is configured to move the light engine along a lateral Y-axis with respect to the carriage. The lateral Y-axis is perpendicular to the lateral X-axis. The 3D printing system also includes a build plate coupled to a vertical movement mechanism and a controller. The controller is configured to: operate the vertical movement mechanism to position a lower face of the build plate or 3D article at the build plane, operate the lateral movement mechanism to sequentially position the carriage and light engine at a series of X-stop positions, at individual X-stop positions, operate the lateral movement mechanism to scan the light engine along the Y-axis, and concurrent with scanning the light engine, operate the light engine to selectively image a column of the build plane and to selectively cure a portion of the photocurable liquid over the column at the X-stop position.

The build plane is defined as a zone of selective curing when a layer of the 3D article is formed. The build plane is a very thin sheet of selectively cured material. A vertical distance between the transparent sheet and the build plane is less than one millimeter (mm) or less than 0.5 mm or less than 0.25 mm. A maximum lateral extent of the build plane is defined by the amount of area of the transparent sheet that can be reached by the light engine which is determined by maximum area that the light engine can image at one time and a maximum area of scanning of the light engine along the lateral X and Y axes.

### BRIEF DESCRIPTION OF THE FIGURES

FIG. 1 is an isometric drawing depicting an embodiment of a three-dimensional (3D) printing system for manufacturing a 3D article.

FIG. 2 is a side cutaway view of an embodiment of a three-dimensional (3D) printing system.

FIG. 3 is an isometric drawing of a build vessel in isolation.

FIG. 4 is a cutaway isometric drawing of a build vessel.

FIG. 5 is an isometric drawing illustrating an embodiment of the lower half of the build vessel.

FIG. 6 is an isometric drawing of a central portion of a carriage in isolation.

FIG. 7 is a sectional view showing a portion of a build vessel.

FIG. 8 is a detail view taken from a portion of FIG. 7.

FIG. 9 is a schematic illustration of a build plane with a carriage in a first position.

FIG. 10 is a schematic illustration of a build plane with a carriage in a second position.

FIG. 11 is a simplified electrical block diagram of a 3D printing system.

FIG. 12 is a flowchart depicting a method of manufacturing a 3D article.

### DETAILED DESCRIPTION OF THE PREFERRED EMBODIMENTS

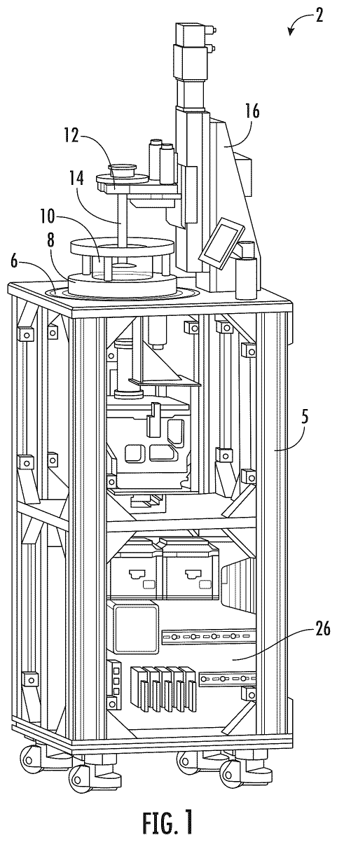

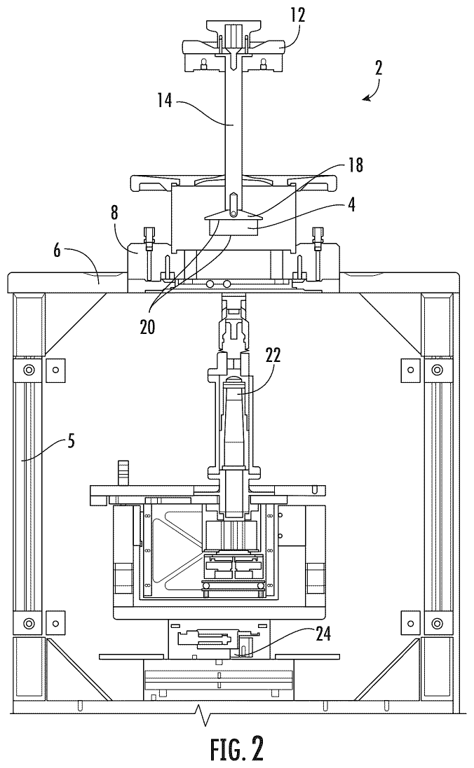

FIG. 1 is an isometric drawing of an embodiment of a three-dimensional (3D) printing system 2 for manufacturing or fabricating a 3D article 4 (FIG. 2) with an outer housing removed to illustrate internal components. In describing 3D system 2, mutually perpendicular axes X, Y, and Z will be used. Axes X and Y are generally horizontal lateral axes. Axis Z is a vertical axis that is generally aligned with a gravitational reference. In using the word “generally” it is implied that a limitation that is “generally” true is by design and to within manufacturing tolerances. Additionally angular axes theta-X, theta-Y, and theta-Z are rotations about the X, Y, and Z axes respectively.

3D printing system 2 includes a chassis or frame 5 having a vessel support 6. A build vessel 8 configured to contain a photocurable liquid 10 is supported by the vessel support 6. A build platform 14 is supported by an elevator 12. A vertical movement mechanism 16 is configured to vertically position the elevator 12.

An embodiment of vertical movement mechanism 16 includes a motorized ball bearing screw mechanism or otherwise referred to as a ball screw mechanism. A ball screw mechanism includes a vertical screw shaft that passes through a ball nut. The ball nut contains recirculating steel balls and translates vertically in response to rotation of the vertical screw shaft. The vertical screw shaft has helical channels that engage the recirculating balls. The elevator 12 includes the ball nut. A motor is coupled to the vertical screw shaft and is configured to selectively rotate the vertical screw shaft. As the vertical screw shaft rotates, the action of the vertical screw shaft upon the ball nut translates the elevator upward and downward depending on a direction of rotation. Such translation mechanisms are known in the art for precision positioning along vertical, horizontal, and oblique axes. Alternative embodiments of vertical movement mechanisms can include a lead screw and nut system or a rack and pinion mechanism or a motorized belt/pulley system. All such movement mechanisms known in the art for linearly translating components along various axes. All references to movement mechanisms described herein can utilize one or more of these known methods.

FIG. 2 is a side cutaway view of 3D printing system 2. Build platform 14 includes a build plate 18 having a lower surface or face 20 for supporting the 3D article 4 being fabricated. Hereafter element number 20 will refer to a lower face 20 of the build plate 18 or of a partially fabricated 3D article 4. A projection light engine or projector 22 is supported on a lateral movement mechanism 24.

Lateral movement mechanism 24 is configured to translate and position projector 22 along lateral axes X and Y. Lateral movement mechanism 24 can also be referred to as an “XY stage” for some embodiments. In an illustrative embodiment, the lateral movement mechanism 24 includes a vertically stacked arrangement of two linear or stepper motors operating at right angles to each other including an “X motor” and a “Y motor”. The motors can act directly or indirectly on the stage to actuate translation of the stage along the X and Y axes. In one embodiment, the motors individually drive a lead screw threaded through a nut. The nut translates linearly in response to motor rotation. This action is similar to that described with respect to the vertical movement mechanism 16. Alternatively, the motors can drive a gear mechanism known as a “gear train”. The gear train is a gear reduction mechanism to enable precision movement. Stacks of motorized X and Y stages are known in the art for precision movement along various axes for printers, 3D printers, robotics, inspection systems, and other devices requiring precision movement.

Referring back to FIG. 1, the 3D printing system 2 includes a controller 26. Controller 26 is configured to operate the vertical movement mechanism 16, the projector 22, the lateral movement mechanism 24, and other portions of system 2. Also, controller 26 is configured to receive information from sensors and feedback devices within chassis 5. In the illustrated embodiment, controller 26 is within chassis 5. However, it is to be understood that controller 26 can also include computer devices external or remote to the chassis 26. Thus controller 26 can include one or more of a microcontroller, a desktop computer, a laptop computer, a mainframe computer, and a server or shared computing devices.

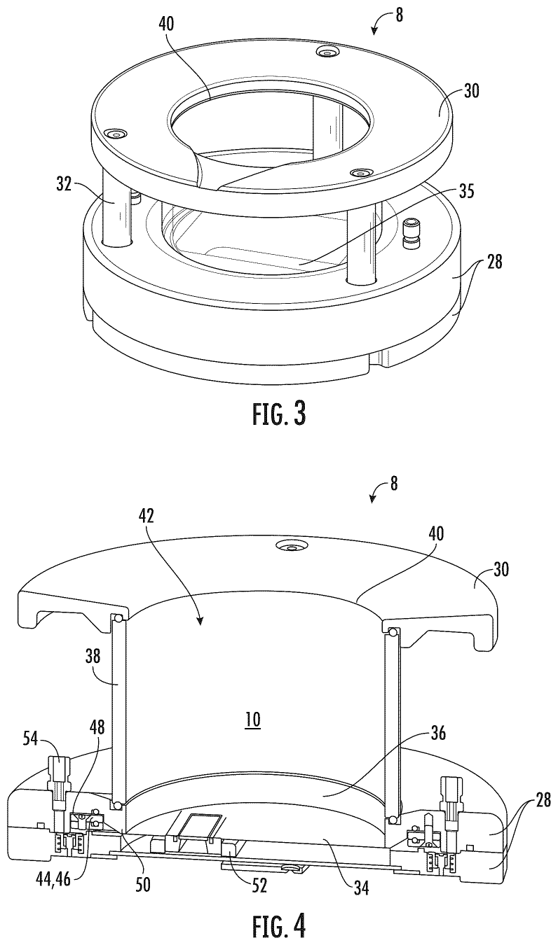

FIG. 3 is an isometric view of the build vessel 8 in isolation. Build vessel 8 includes a vessel base 28 coupled to a top 30 by dowels 32. When build vessel 8 is installed in 3D printing system 2, the vessel base 28 aligns to the vessel support 6.

FIG. 4 is a cutaway isometric view of build vessel 8. A transparent sheet 34 closes an opening 36 in the vessel base 28. A wall 38 extends vertically between the vessel base 28 and an opening 40 in the top 30 of the build vessel 8. The vessel base 28, transparent sheet 34, and wall 38 provide a fluid vessel 42 for containing the photocurable liquid 10.

In an illustrative embodiment, the transparent sheet 34 is a polymer sheet that is transparent to radiation in the blue to ultraviolet (UV) range or about 100 to 500 nanometers (nm). The polymer can be an amorphous polymer known in the art to provide optical clarity, low refractive index, and other properties desirable for this application. The polymer is also diffusively transmissive to oxygen which provides an inhibitor to prevent buildup of hardened photocurable material on the transparent sheet 34. Such polymers are known in the art for certain stereolithography implementations. Other polymers can also be used if they have a similar set of properties.

The photocurable liquid 10 can be a photocurable “bio-ink” or a photocurable resin. The photocurable liquid 10 generally contains, inter alia, a monomer and a catalyst. In response to blue to UV radiation, the catalyst causes the monomer to polymerize or cross-link and solidify. Various photocurable bio-inks and resins are known in the art of stereolithography.

In the illustrated embodiment, the projector 22 (ref. FIG. 2) is a projection-based light engine. The projector 22 includes a light source, a spatial light modulator, and projection optics. The light source illuminates the spatial light modulator with electromagnetic radiation having a wavelength in a blue to ultraviolet range. The spatial light modulator includes an array of micromirrors that individually have two states—an ON state at which a small beam of light is transmitted to the projection optics—an OFF state in which the light reaching the micromirror is diverted into a light trap and does not reach the projection optics. The projection optics project and focus small beams of light received onto a build plane 35 that is above the transparent sheet 34. The build plane 35 is a thin (less than 0.1 millimeter (mm) thick) planar or parallelepiped region along which a new layer of hardened photocurable liquid 10 is accreted on to a lower face 20 of the build plate 18 or the 3D article 4 during fabrication of the 3D article 4. A lateral extent of the build plane 35 is defined by the lateral extent of radiation that can be applied by the projector 22 (taking into account scanning of the laser by the lateral movement mechanism 24) during formation of a layer of the 3D article 4.

A frame 44 clamps a peripheral edge 46 of the transparent sheet 34. The frame 44 is mounted in a recess 48 formed into the vessel base 28. The base includes a tension ring or ridge 50 that stretches the transparent sheet 34.

The vessel base 28 includes a carriage 52 configured to provide a localized support to the transparent sheet 34. Carriage 52 is fluidically coupled to a gas inlet 54 which is in turn coupled to a gas pressure source (not shown and to be described infra). A combination of the gas pressure source and carriage 52 is configured to support the transparent sheet 34 along a column of the build plane 35.

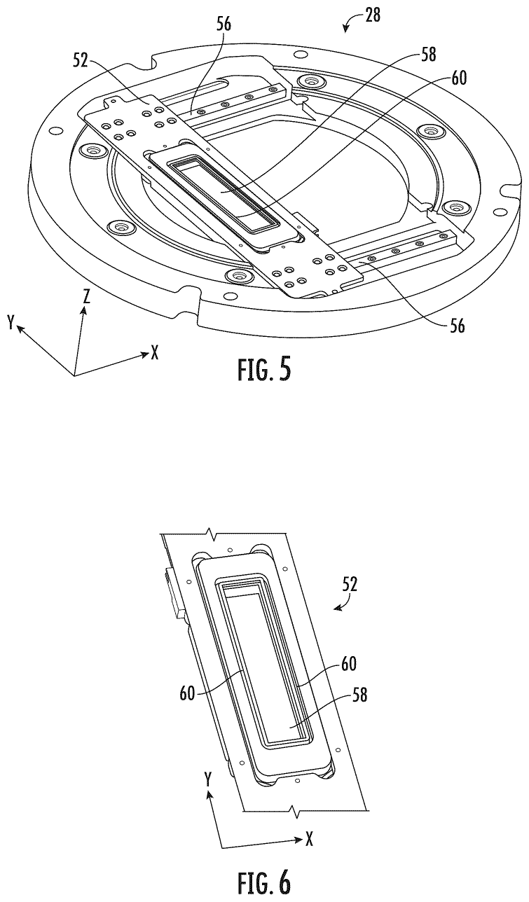

FIG. 5 is an isometric drawing illustrating an embodiment of a portion of a vessel base 28 in isolation. Carriage 52 is mounted to the vessel base 28 by a pair of linear bearings 56. The linear bearings 56 are at opposed ends of the carriage 52 with respect to the Y-axis. Carriage 52 includes an optical window 58 that allows radiation from the projector 22 to pass up to the build plane 35. Carriage 52 also includes a fluid channel 60 that is fluidically coupled to the gas inlet 54. In the illustrated embodiment, the fluid channel 60 surrounds the optical window 58. The lateral movement mechanism 24 is configured to translate the projector 22 and carriage 52 together along the X-axis.

FIG. 6 is an isometric drawing of a central portion of the carriage 52 in isolation. The optical window 58 can be an opening in carriage 52. Alternatively, the optical window 58 can include a transparent plate such as a glass plate or a quartz plate or other plate material that is transparent within the blue to UV range of radiation. In the illustrated embodiment, the fluid channel 60 is a slot that passes around and thus surrounds the optical window 58. Alternatively, the fluid channel 60 can include a plurality of separate segments or openings that surround some or all sides of the optical window 58.

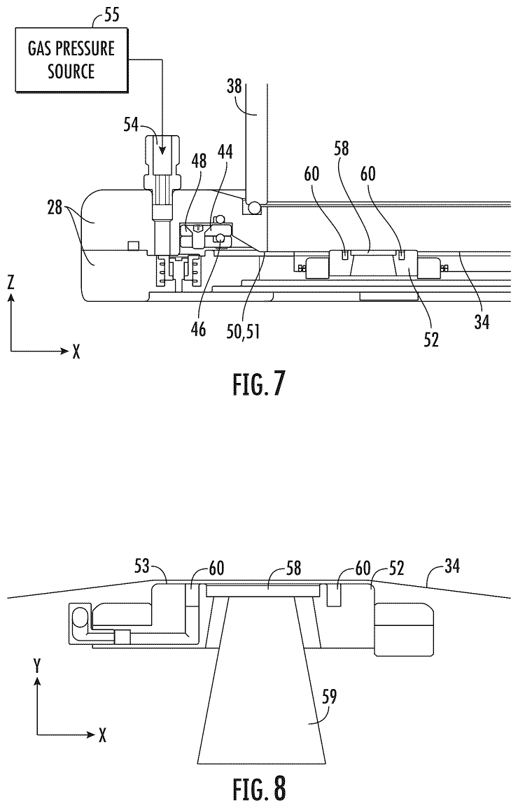

FIG. 7 is a sectional view showing a portion of the build vessel 8 including a portion of vessel base 28. The vessel base 28 defines the recess 48 containing frame 44. Frame 44 clamps a peripheral edge 46 of the transparent sheet 34. The transparent sheet 34 is stretched over a lower surface or rim 51 of tension ring 50. Carriage 52 is slidingly mounted to the vessel base 28. A gas pressure source 55 is fluidically coupled to the gas inlet 54 and the fluid channel 60. Gas (such as air and/or nitrogen) flows from the base pressure source 55, to the gas inlet 54, and out the fluid channel 60. Without the gas flow, the transparent sheet would press against an upper surface 53 of the carriage 52. With the gas flow, a gap is maintained between the transparent sheet 34 and the upper surface 53.

In an illustrative embodiment, the gas pressure source 55 is a pressurized air delivery system. In one embodiment, the gas pressure source 55 can include a low volume air pump such as a diaphragm pump. In another embodiment, the gas pressure source can include a bottle of pressurized gas including oxygen and a regulator. Various embodiments are possible for delivering pressurized gas.

FIG. 8 is a detail view taken from FIG. 7 focusing on the transparent sheet 34 and carriage 52. The gas flowing out of the fluid channel 60 maintains a vertical spacing or gap between the carriage 52 and the transparent sheet 34. Also shown is an optical path 59 of radiation which passes through the optical window 58 and to the build plane 35. The optical path 59 of radiation ends in a pixelated rectangular area on build plane 35.

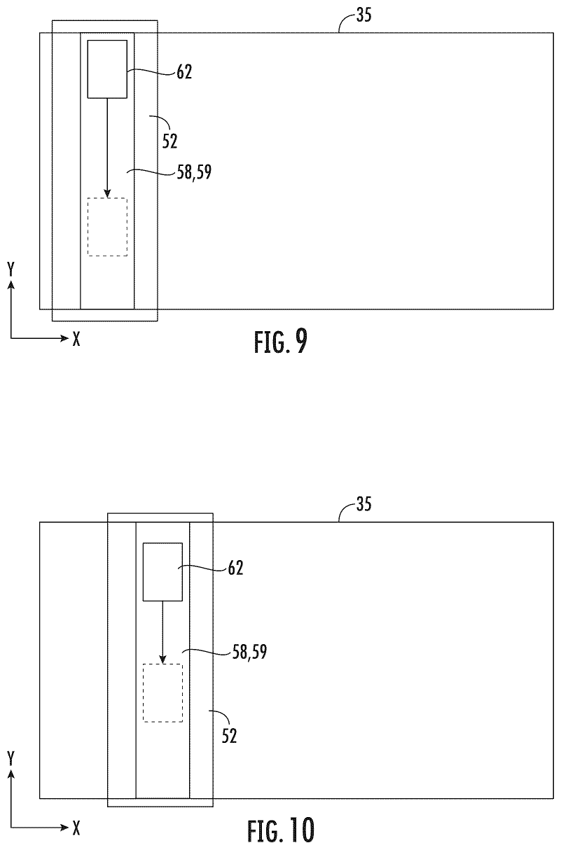

FIGS. 9 and 10 are schematic diagrams illustrating a sequential and selective irradiation of build plane 35. In FIG. 9, the carriage 52 and hence the optical window 58 is positioned at a first position with respect to the X-axis. The carriage 52 is positioned at a first “X-stop” location. At the first X-stop location, the optical window 58 overlays a first column or stripe 59 of the build plane 35. At the first X-stop, the projector 22 is scanned along the Y-axis relative to the carriage 52. Therefore a rectangular projection of pixelated radiation 62 is scanned over the first column along the Y-axis. As a note, the first column may be shorter along the Y-axis than the optical window 58 if a cross section of the article 4 at the build plane 35 does not completely span the build plane along Y. After the first column is thus scanned, the carriage 52 is moved to a second X-stop position as illustrated in FIG. 10. At the second X-stop, the scanning of projector 22 and selective irradiation along the Y-axis is repeated. This continues until the build plane 35 is selectively irradiated according to the layer of the 3D article 4 being fabricated.

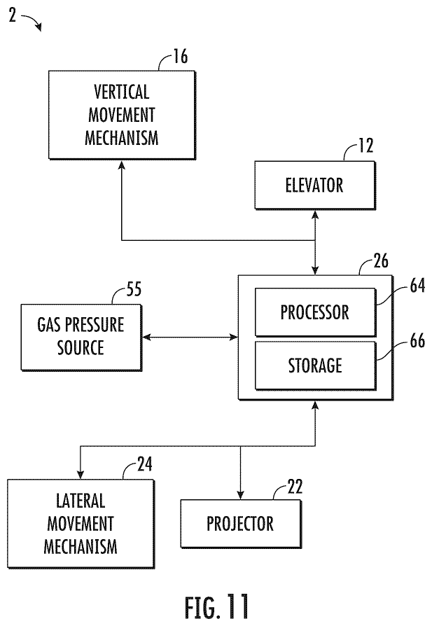

FIG. 11 is a simplified electrical block diagram of 3D printing system 2. The controller 26 includes a processor 64 coupled to an information storage 66. The information storage 66 includes one or more non-transient or non-volatile storage devices that store software instructions. When executed by the processor 64, the software instructions control portions of the 3D printing system 2 including the elevator 12, vertical movement mechanism 16, the projector 22, lateral movement mechanism 24, and gas pressure source 55.

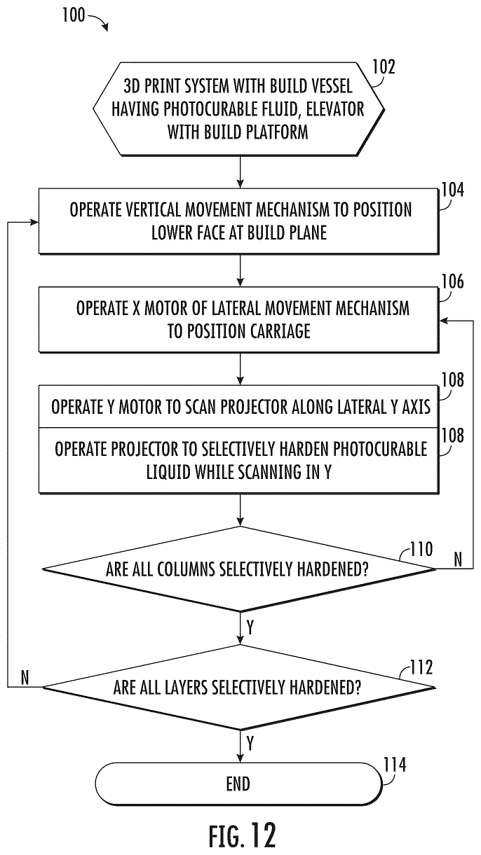

FIG. 12 is a flowchart depicting a method 100 of manufacturing the 3D article 4. According to 102, the 3D printing system is ready for operating with a photocurable liquid 10 placed in the build vessel 8. Also according to 102, the gas pressure source 55 is activated so that pressurized gas (such as air or nitrogen) flows out of source 55, into the gas inlet 54, to the fluid channel 60, and out of fluid channel 60 to maintain a vertical spacing between the carriage 52 and the transparent sheet 34. According to 104, the vertical movement mechanism 16 is operated to position the lower face or surface 20 of build plate 18 (and later partially formed 3D article 4) at the build plane 35.

According to 106 the X motor of the lateral movement mechanism 24 is operated to position the carriage 52. According to 108, the Y motor of the lateral movement mechanism 24 is operated to scan the projector 22 (and hence the pixelated pattern 62) over a stripe of the build plane 35 within the optical window 58. Also according to 108, concurrent with the scanning, the projector 22 is operated to selectively irradiate the stripe or column of the build plane 35.

According to 110, a determination is made as to whether all columns of the build plane 35 have been selectively cured at a particular layer. If the answer is NO, then the process loops back to 106 to move to the next column. If the answer is YES, then the process moves to 112 to determine whether all layers of the 3D article have been selectively imaged. If the answer is NO, then the process loops back to 104 to move the lower face 20 to the build plane 35. If the answer is YES, then the method terminates according to 114.

The specific embodiments and applications thereof described above are for illustrative purposes only and do not preclude modifications and variations encompassed by the scope of the following claims.

For example, in a first alternative embodiment, the projector 22 is configured to illuminate a full width of the build plane 35 along the Y-axis. Then there is no need for movement of the projector 22 along the Y-axis. In this first alternative embodiment, the projector 22 can scan along the X-axis. Concurrent with the scanning, the projector 22 is operated to selectively irradiate the build plane 35.

In a second alternative embodiment, projector 22 includes multiple projectors 22 that are arranged along the Y-axis. In this second alternative embodiment, the multiple projectors 22 can fully irradiate an entire column without scanning along the Y-axis.

In a third alternative embodiment, projector 22 includes multiple projectors 22 that are arranged along the Y-axis. These projectors 22 are scanned along the Y-axis (as with the method 100) but only for a fraction of a width of the build plane 25 along the Y-axis.

In all of the above embodiments, the carriage 52 provides pressurized gas to maintain a spacing between the transparent sheet 34 and the carriage 52 as described with respect to FIGS. 4-8.

What is claimed:

1. A three-dimensional (3D) printing system configured to manufacture a 3D article comprising:
a machine chassis including a vessel support and a gas pressure source;
a build vessel supported by the vessel support, the build vessel including:
a vessel base having a central opening;
a vessel wall extending upward from the vessel base; and
a transparent sheet closing the central opening of the vessel base, the vessel wall and the transparent sheet cooperate to define a fluid reservoir for containing a photocurable fluid;
the vessel support or the vessel base including a carriage having a top surface and is configured to be positioned along a lateral X axis under the transparent sheet, the carriage defining:
an optical path; and
a fluid channel that at least partially surrounds the optical path;
the gas pressure source coupled to the fluid channel, gas flowing from the gas pressure source and out of the fluid channel is configured to maintain a vertical spacing between the top surface of the carriage and the transparent sheet;
a light engine configured to selectively transmit radiation through the optical path and to a build plane that is above the transparent sheet; and
a lateral movement mechanism configured to position the carriage and the light engine along the lateral X axis, the carriage and the light engine are configured to move together with respect to the lateral X axis.

2. The three-dimensional (3D) printing system of claim 1 wherein the vessel base includes a tension ring that presses downward and laterally tensions the transparent sheet, the tension ring laterally surrounds the build plane.

3. The three-dimensional (3D) printing system of claim 2 wherein the vessel base defines a recess that laterally surrounds the tension ring and further comprising a support frame disposed within the recess, the support frame clamps a peripheral edge of the transparent sheet.

4. The three-dimensional (3D) printing system of claim 3 wherein the tension ring presses downward along a closed surface of the transparent sheet that is below the peripheral edge of the transparent sheet.

5. The three-dimensional (3D) printing system of claim 1 wherein the lateral movement mechanism is configured to move the light engine along a lateral Y-axis with respect to the carriage, the lateral Y-axis is perpendicular to the lateral X-axis.

6. The three-dimensional (3D) printing system of claim 5 further comprising a build plate coupled to a vertical movement mechanism.

7. The three-dimensional (3D) printing system of claim 6 further comprising a controller configured to:
operate the vertical movement mechanism to position a lower face of the build plate or 3D article at the build plane;
operate the lateral movement mechanism to sequentially position the carriage and light engine at a series of X-stop positions;
at individual X-stop positions, operate the lateral movement mechanism to scan the light engine along the Y-axis; and
concurrent with scanning the light engine, operate the light engine to selectively image a column of the build plane at the X-stop position.

8. The three-dimensional (3D) printing system of claim 1 wherein the light engine is stationary with respect to the Y-axis and wherein the light engine spans the build plane along the Y-axis.

9. The three-dimensional (3D) printing system of claim 1 wherein the light engine includes a plurality of light engines arranged along the X-axis.

10. A method of manufacturing a 3D article using the 3D printing system of claim 6 comprising:
operating the vertical movement mechanism to position a lower face of the build plate or 3D article at the build plane;
operating the lateral movement mechanism to sequentially position the carriage and light engine at a series of X-stop positions;
at individual X-stop positions, operating the lateral movement mechanism to scan the light engine along the Y-axis; and
concurrent with scanning the light engine, operating the light engine to selectively image a column of the build plane at the X-stop position.

11. A three-dimensional (3D) printing system configured to manufacture a 3D article comprising:
a machine chassis including a vessel support and a gas pressure source;
a build vessel supported by the vessel support, the build vessel including:
a vessel base having a central opening;
a vessel wall extending upward from the vessel base; and
a transparent sheet closing the central opening of the vessel base, the vessel wall and the transparent sheet cooperate to define a fluid reservoir for containing a photocurable fluid;
the vessel support or the vessel base including a carriage having a top surface and is configured to be positioned along a lateral X-axis under the transparent sheet, the carriage defining:
an optical path; and
a fluid channel that at least partially surrounds the optical path;
the gas pressure source coupled to the fluid channel, gas flowing from the gas pressure source and out of the fluid channel is configured to maintain a vertical spacing between the top surface of the carriage and the transparent sheet;
a build plate coupled to a vertical movement mechanism;
a projector configured to selectively transmit radiation through the optical path and to a build plane that is above the transparent sheet;
a lateral movement mechanism configured position the carriage and projector together along the lateral X-axis and to scan the projector relative to the carriage along a lateral Y-axis that is perpendicular to the lateral X-axis; and
a controller programmed to operate the projector and the lateral movement mechanism.

12. The three-dimensional (3D) printing system of claim 11 wherein the vessel base includes a tension ring that presses downward and laterally tensions the transparent sheet, the tension ring laterally surrounds the build plane.

13. The three-dimensional (3D) printing system of claim 12 wherein the vessel base defines a recess that laterally surrounds the tension ring and further comprising a support frame disposed within the recess, the support frame clamps a peripheral edge of the transparent sheet.

14. The three-dimensional (3D) printing system of claim 13 wherein the tension ring presses downward along a closed surface of the transparent sheet that is below the peripheral edge of the transparent sheet.

15. The 3D printing system of claim 11 wherein the controller is configured to operate the vertical movement mechanism, the lateral movement mechanism, and the projector to form a plurality of N layers that form the 3D article, for individual layers:
operate the vertical movement mechanism to position a lower face of the build plate or 3D article at the build plane; and
operate the lateral movement mechanism position the carriage and the projector at a sequence of positions along the lateral X-axis, at individual positions:
operate the lateral movement mechanism to scan the projector along the lateral Y-axis under a portion of the optical path; and
concurrent with scanning the projector, operate the projector to selectively harden the photocurable liquid at the build plane and along the portion of the optical path.

16. The three-dimensional (3D) printing system of claim 11 wherein the light engine includes a plurality of light engines arranged along the X-axis.

17. A method of manufacturing a 3D article using the 3D printing system of claim 11 comprising:
forming a plurality of N layers that form the 3D article, for individual layers:
operating the vertical movement mechanism to position a lower face of the build plate or 3D article at the build plane; and
operating the lateral movement mechanism position the carriage and the projector at a sequence of positions along the lateral X-axis, at individual positions:
operating the lateral movement mechanism to scan the projector along the lateral Y-axis under a portion of the optical path; and
concurrent with scanning the projector, operating the projector to selectively harden the photocurable liquid at the build plane and along the portion of the optical path.

18. A three-dimensional (3D) printing system configured to manufacture a 3D article comprising:
a machine chassis including a vessel support and a gas pressure source;
a build vessel supported by the vessel support, the build vessel including:
a vessel base having a central opening;
a vessel wall extending upward from the vessel base;
a transparent sheet closing the central opening of the vessel base, the vessel wall and the transparent sheet cooperate to define a fluid reservoir for containing a photocurable fluid; and
a carriage having a top surface and is configured to be positioned along a lateral X axis under the transparent sheet, the carriage including:
an optical closed by a transparent plate; and
a fluid channel fluidically coupled to the gas pressure source and that at least partially surrounds the optical path;
a light engine configured to selectively transmit radiation through the optical path and to a build plane that is above the transparent sheet;
a lateral movement mechanism configured to position the carriage and the light engine along the lateral X axis, the carriage and the light engine move together with respect to the lateral X axis;
a build plate coupled to the vertical movement mechanism; and
a controller programmed to:
operate the vertical movement mechanism to position a lower face of the build plate or the 3D article at the build plane;
operate the lateral movement mechanism to scan or sequentially step the carriage and the light engine in tandem along the X-axis;
concurrent with operating the lateral movement mechanism, operate the light engine to selectively irradiate pixels over the build plane; and
repeat operating the vertical movement mechanism, the lateral movement mechanism, and the light engine to complete fabrication of the 3D article in a layer-by-layer manner while gas flowing from the gas pressure source and through the fluid channel maintain a spacing between the carriage and the transparent sheet.
